(19) United States
(12) Patent Application Publication
(10) Pub. No.: US 2003/0121208 A1
(43) Pub. Date: Jul. 3, 2003

(54) Low clearance door track

(76) Inventors: James R. Rothwell SR., Chattanooga, TN (US); William G. Pardue SR., Chattanooga, TN (US)

Correspondence Address: Charles E. Baxley, Hart, Baxley, Daniels & Holton, Fifth Floor, 59 John Street, New York, NY, 10038, US

(21) Appl. No.: 09/821,062

(22) Filed: Mar. 30, 2001

(51) Int. Cl. E05D 15/10

(52) U.S. Cl. 49/213; 49/208; 49/163

(57) ABSTRACT

An apparatus is disclosed for a door track to accommodate low overhead areas using a horizontal rail that splits into an upper spur and a lower spur with the lower spur curving downwardly to form a vertical rail. The inverted T cross section of the rails accommodates the rollers of sectional doors while the upright T cross section of the upper spur provides guidance for the uppermost panel of a sectional door in order to achieve vertical alignment of all sectional door panels when the door is closed.

### FIELD OF THE INVENTION

This invention relates to the field of sectional doors and more particularly to railing systems for sectional doors with low overhead space.

### BACKGROUND OF THE INVENTION

When doors are installed to cover large openings such as those found in garages, the range of door types and associated railing systems employed can be limited due to a lack of overhead space. Conventional railing or track systems for sectional doors extend appreciably above the height of the opening, normally requiring at least 18 inches, thereby precluding their use in areas with low ceilings or little overhead space.

Single piece doors have been used as a solution for areas with low ceilings. The single piece door will generally have a vertical track or rail and may employ a horizontal track. The door will have a lower set of rollers to guide the door in the vertical track. In the case of the railing system with a horizontal track, the door will also have rollers at the top for guiding the door along the horizontal rail. The horizontal railing is installed at a height that is approximately equal to the door height. For all single piece door railing systems, when the door is opened, the door pivots around the lower rollers, resulting in the bottom of the door kicking outwardly. Because of the pivoting and kicking out of the door, safety is a primary concern with single piece doors. It is difficult to detect when small children or pets are in the door's path.

Efforts to design low overhead railing systems for sectional doors have focused on dual tracks or bilateral channels for its door rollers. The uppermost panel of a sectional door is guided by an upper rail or track that is independent and separate from a lower rail or track that guides the remaining panels of a sectional door. A lack of overhead space requires the rollers in the uppermost panel to travel along the upper rail so that the uppermost panel aligns vertically with the rest of the door panels when closed. Without separate rails or tracks, the uppermost panel would follow the curvature of the lower rail and would not finish in vertical alignment. The necessity of the second rail adds to the manufacturing, installation, and maintenance costs of a low clearance railing system for overhead doors.

Accordingly, there is a need to provide a single track railing system for sectional doors in areas with low overhead space.

### SUMMARY OF THE INVENTION

The present invention teaches a railing system for sectional doors in areas with little overhead space. The disclosed invention provides a guiderail having a horizontal rail portion that extends from a proximal end within the enclosed area and towards a distal end where the horizontal rail portion diverges between a lower spur and an upper spur. The lower spur curves downwardly to form a vertical rail portion. The vertical and horizontal rail portions have cross sections similar to an inverted T to enable the rollers of a sectional door to be securely guided within the respective rail portions. By providing an upper spur with a cross section similar to an upright T, when the door is closed, the uppermost panel of a sectional door can be smoothly guided into the upper spur and align vertically with the remaining panels of the sectional door that have progressed down the lower spur and vertical rail portion.

In exemplary embodiments, the upper spur and vertical rails are connected to a wall or column with a set of brackets. In one embodiment, the lower spur and the vertical rail are separate pieces that can be connected together as well as disconnected, thereby simplifying the process of manufacturing, packaging, and installation.

Advantageously, the present invention can be used in a variety of areas where overhead space is an issue. By designing the railing system with one track, the present invention can be easily be adapted to any type of sectional door. Importantly, the curvature of the lower spur forces the door sections to separate more completely than conventional rail systems, thereby allowing complete maintenance accessibility to the otherwise hidden door sections. The present invention is an efficient and effective solution to providing extremely low overhead railing systems for sectional doors.

### BRIEF DESCRIPTION OF THE DRAWINGS

A more complete understanding of the present invention may be obtained from consideration of the following description in conjunction with the drawings in which:

FIG. 1 is an illustration of the low clearance door track.

FIG. 2 is a cross sectional view of an exemplary horizontal rail portion.

### DETAILED DESCRIPTION

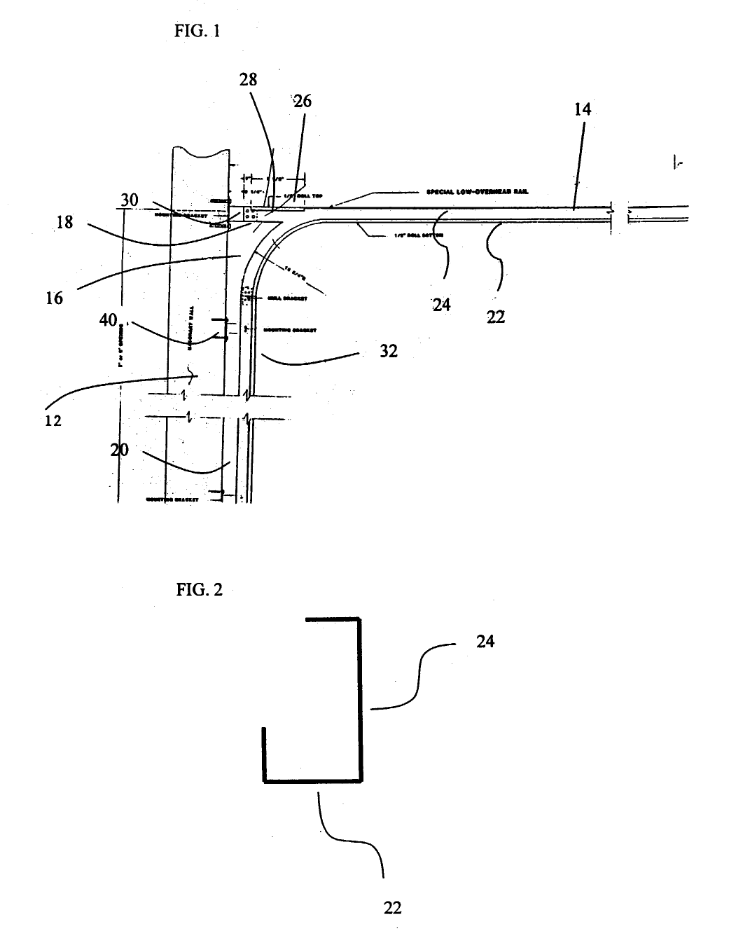

The exemplary low clearance door track can be seen in FIG. 1. The track comprises a plurality of components including horizontal and vertical rails to support an articulated or sectional door that will enclose an open area in a building or structure. These components are integrated to achieve the desired objective of providing a single track system for sectional doors in buildings or structures where overhead space is extremely limited.

The horizontal rail portion 14 extends from a point within an enclosed area towards a wall 12. While the horizontal rail portion can be varied in length to support different door sizes, it is envisioned that the standard length of the horizontal rail portion will be 8.5′ or 9.5′ in length. Similarly, the installation height of the horizontal rail portion 14 can be varied on the basis of the door height but in general, the installation height is approximately the same as the door height, thereby allowing installation in areas with extremely low overheads.

In FIG. 2, a cross section of the horizontal rail 14 has the appearance of an inverted T. More specifically, the bottom portion of the inverted T comprises a horizontal flange portion 22 with a first web portion 24 that projects upwardly from the horizontal flange portion 22. In a preferred embodiment, the horizontal flange portion 22 creates a bottom roll of one-half inch, suitable for a sectional door's rollers. Thus, the horizontal rail portion 14 is designed to guide the rollers of a sectional door while simultaneously supporting the sectional door.

As the horizontal rail portion 14 extends towards the wall 12, it splits into a lower spur 16 and an upper spur 18. The lower spur 16 curves downwardly in vicinity of the wall 12 to form a vertical rail portion 20. The lower spur 16 forms an arc of approximately 90 degrees. In a preferred embodiment, the arc is consistent with a circle having a radius of 13.75 inches to the furthermost point of the first web portion 24. The upper spur 18 will guide the rollers of the uppermost panel of a sectional door while the lower spur 16 will guide the rollers of the remaining or lower panels of a sectional door. Because the radius is small, the panels of the sectional door pivot more fully, thereby exposing the hidden portion of each panel. This enables the user of the exemplary door track to more easily and completely clean or paint the hidden portions of the panels and increase the life of the door.

The vertical rail portion 20 has a cross section similar to the horizontal rail portion 14. Here, the vertical rail portion 20 has a vertical flange portion 32 that is positioned inwardly relative to the enclosed area with a first web portion 24 projecting outwardly relative to the enclosed area or towards the wall 12. Thus, the vertical flange portion 32 creates a roll that secures the rollers of the lower door panels to the vertical rail portion 20. In a preferred embodiment, the vertical flange portion 32 creates a roll of one-half inch.

FIG. 1 illustrates an embodiment of the vertical rail portion 20 where the lower spur 16 is removably connected to the vertical rail portion 20. It is envisioned that a bracket and fastener can be employed to secure the lower spur 16 to the vertical rail portion 20. By initially allowing the vertical rail portion 20 to be separate from the lower spur 16, the present invention can be more easily manufactured, packaged, and installed.

The upper spur 18, as an extension of the horizontal rail portion 14, continues in towards the wall 12 in order to facilitate a secure connection of the present invention to the wall 12. The upper spur 18 has a cross section that has the appearance of an upright T. The upper spur 18 has an upper flange portion 26 with a continuation of the first web portion 28 projecting downwardly from the upper flange portion 26. In a preferred embodiment, the upper flange portion 26 is 7.5 inches in length, beginning one inch from the end of the upper spur 18 nearest to the wall 12.

Operation of a sectional door with the present invention is straightforward. With the door in an open position, the rollers of the uppermost panel are resting in the horizontal rail portion 14 at the end within the enclosed area. The rollers on the remaining door panels are also resting in the horizontal rail portion 14 with the exception of the lowermost panel. The rollers of the lowermost panel are resting in the lower spur 16. When the door is closed, the lowermost panel of the door continues down the lower spur 16 into the vertical rail portion 20. The remaining panels, with the exception of the uppermost panel, follow the lowermost panel into the lower spur 16 and down the vertical rail portion 20. While the door is closing, the weight of the panels remaining in the horizontal rail portion 14 keeps the rollers engaged with the horizontal flange portion 22 and provide a smooth transition from the horizontal rail portion 14 to the lower spur 16. When the bottom of the lowermost panel is guided down the vertical rail portion 20 and engages the ground, the rollers of the uppermost panel are coincident with the split between the lower spur 16 and the upper spur 18. Because the lowermost panel is engaged with the ground, the uppermost panel cannot continue further down the lower spur 16. Instead, as additional forward force is applied to the uppermost panel, it pivots upwardly, releasing the rollers from the horizontal flange portion 22 and guiding the uppermost panel into the upper spur 18 where the rollers will engage the upper flange portion 26 and guide the uppermost panel into a vertical alignment with the lower panels. Because all of the door panels are aligned vertically, a firm fit is insured along with the associated improvement in insulating ability.

When the door is in a closed position, it is opened by pulling the uppermost panel of a sectional door along the upper spur 18 towards the horizontal rail portion 14. The uppermost panel must initially be pulled horizontally in order for the door to open. The door cannot be opened by pulling upwardly the lowermost panel, making a forced entry almost impossible. It is only after the uppermost panel progresses along the horizontal rail portion 14 that the lower panels of the sectional door can progress up the vertical rail portion 20 into the lower spur 16 and finally along the horizontal rail portion 14, stopping with the lowermost panel of a sectional door resting in a portion of the lower spur 16. A preferred means for opening and closing a sectional door with the exemplary door track is with an electronic garage door opener.

An illustrated in FIG. 1, a first bracket 30 is connected to the wall. The first web portion 24 in the upper spur 18 overlaps the first bracket 30. Fasteners are then used to secure the first web portion 24 of the upper spur 18 to the first bracket 30. A plurality of additional brackets 40 can also be connected to the wall 12. Here, the additional brackets 40 overlap the first web portion 24 of the vertical rail portion 20. Fasteners are then used to secure the additional brackets 40 to the first web portion 24 of the vertical rail portion 20. Alternatively, the wall 12 can consist of a column, whereby the first bracket 30 and the additional brackets 40 are mounted onto the column. In either case, a secure attachment is made to the present invention, thereby providing strength and stability.

It will be understood that the embodiment of the present invention specifically shown and described is merely exemplary and that a person skilled in the art can make alternate embodiments using different configurations and functionally equivalent components. All such alternate embodiments are intended to be included in the scope of this invention as set forth in the following claims.

What is claimed:

1. A guiderail for an articulated door, organized for movement between a closed condition wherein the door is positioned in an opening formed in a wall of a building and a recessed condition wherein the door is positioned higher than the opening in proximity of a ceiling forming part of the building, the guiderail comprising:
a horizontal rail portion extending from a proximal end within the building and toward a distal end which diverges between a lower spur and an upper spur, the lower spur curving downwardly in vicinity of the wall to form a vertical rail portion;
the horizontal rail portion having a cross section which defines an inverted T with a horizontal flange portion and a first web portion projecting upwardly from the horizontal flange portion;
the vertical rail portion having a cross section with a vertical flange portion positioned inwardly relative to the building and with the first web portion projecting outwardly relative to the building from the vertical flange portion; and
the upper spur extending straight to the wall for connection thereto, the upper spur having a cross section which defines an upright T having an upper flange portion and a continuation of the first web portion projecting downwardly from the upper flange portion.

2. The guiderail as claimed in claim 1 and;
a first bracket connected to the wall,
a distal end of the continuation of the first web portion connectable to the first bracket.

3. The guiderail as claimed in claim 2 and;
the lower spur removably connected to the vertical rail portion.

4. The guiderail as claimed in claim 3 and;
at least one additional bracket connected to the wall;
the first web portion connected to the additional bracket.

5. The guiderail as claimed in claim 4 and;
the wall provided with a column;
the first bracket and the additional bracket mounted on the column.

6. The guiderail as claimed in claim 5 and;
the column positioned between the opening and an additional opening also formed in the wall,
hereby the guiderail accommodates both said movement of the articulated door and movement of an additional articulated door between a closed condition wherein the additional door positioned in the additional opening and a recessed condition wherein the additional door is positioned higher than the additional opening in proximity of the ceiling.
